(19) United States
(12) Patent Application Publication
(10) Pub. No.: US 2010/0011841 A1
(43) Pub. Date: Jan. 21, 2010

(54) APPARATUS AND METHODS FOR TESTING ASPHALT MIX WORKABILITY

(76) Inventors: Walaa S. MOGAWER, South Dartmouth, MA (US); Alexander J. AUSTERMAN, Wareham, MA (US)

Correspondence Address: HESLIN ROTHENBERG FARLEY & MESITI PC, 5 COLUMBIA CIRCLE, ALBANY, NY, 12203, US

(21) Appl. No.: 12/503,630

(22) Filed: Jul. 15, 2009

Related U.S. Application Data
(60) Provisional application No. 61/081,584, filed on Jul. 17, 2008.

(51) Int. Cl. G01N 11/14; E01C 21/00

(52) U.S. Cl. 73/54.31; 404/92

(57) ABSTRACT

An apparatus for testing the workability of asphalt mixes includes a frame, a motor operably attached to the frame for rotating a turntable, a container attachable to the turntable, and a paddle for mixing a first asphalt mixture in the container. A torque meter is operably attachable to the frame and to the paddle to measure in real-time the torque applied to the paddle shaft, and a temperature sensor measures the temperature in real-time of the first asphalt mixture in the container. In one embodiment the paddle has a vertical shaft, a plurality of laterally-extending elongated arms attached at first ends to the shaft and at distal second ends to angled plates. In another embodiment, a display and a processor are provided for automatically displaying on the display in real-time a plot of the torque verses time and the temperature verses time for the measured torque and temperature while mixing the asphalt mixture.

### CLAIM TO PRIORITY

This application claims the benefit of U.S. Provisional Application No. 61/081,584, filed Jul. 17, 2008, entitled “Apparatus And Methods For Testing Asphalt Mix Workability,” the entire subject matter of which is hereby incorporated herein by reference.

### FIELD OF THE INVENTION

This invention relates generally to apparatus and methods for testing asphalt mixes, and more particularly to apparatus and methods for testing the asphalt mix workability.

### BACKGROUND OF THE INVENTION

Several devices have been employed for testing hot mix asphalt workability. One device was developed by InstroTek® Inc. for the National Center for Asphalt Technology (NCAT), Auburn University, Alabama. As shown in FIGS. 1 and 2, a device 1000 for testing the workability of the hot mix asphalt includes a motor 1012 supported on a frame 1014 that rotates a paddle shaft 1016 connected to a paddle 1020 (FIG. 2) at a constant speed to mix an asphalt mix in a container 1017. As best shown in FIG. 2, paddle 1020 includes three blades. The blades of the paddle were kept at different elevations so that the chance of developing a shear plane during the test was minimized. The angle of a bottom blade 1022 was disposed at 45-degrees to the direction of rotation to lift mix from the bottom of the container. A middle blade 1024 was disposed perpendicular to the direction of rotation of the paddle, but it was curved slightly to the inside to prevent the segregation of larger particles toward the edge of the container and to continuously remix these larger particles with the remaining sample. A top blade 1026 was inclined at 45-degrees to the direction of rotation of the paddle to force the asphalt mix downward. Instrumentation 1018 recorded the torque required to maintain the paddle shaft at the constant speed. The temperature of the asphalt mix was also recorded. The device is further disclosed in Gudimettla, Jagan M., Cooley, L. Allen, and Brown E. Ray, “Workability of Hot Mix Asphalt,” National Center for Asphalt Technology (NCAT), NCAT Report #03-03, April 2003.

A second device was developed by Dr. Raj Dongre of Dongre Laboratory Services Inc. (DLSI). As shown in FIG. 3, a device 1030 included a motor 1032 which rotates a container 1034 containing an asphalt mix. The container was rotated at a constant speed and a stationary paddle shaft 1036 was inserted into the container of asphalt mix. A reactionary torque meter was placed onto the shaft to measure the resistive torque of the asphalt mix during testing. Temperature measurements were also recorded. The device is further described in a presentation by Dr. Raj Dongre of Dongre Laboratory Services Inc. (DSLI) and Delmar Salomon of Idaho Asphalt, entitled “New Workability Device for Asphalt Emulsion Cold Mixes and Hot-Mix Asphalt,” 2006.

A third hot mix asphalt workability device was presented in a work completed by Worcester Polytechnic Institute (WPI), Worcester, Mass. As shown in FIG. 4, a device 1040 included a paddle 1042 connected to a torque wrench 1044 for measuring the workability of an asphalt mix. A heated asphalt mix sample (not shown in FIG. 4) was first placed in a container 1046 supported on foot stands 1048. Next, an operator rotated the paddle one full revolution using the torque wrench and recorded the torque value displayed on the wrench. The temperature of the sample was then taken. This process was repeated four times at varying time intervals after the sample was introduced into the container. The device and process is further described in Mallick, Rajib B., Bradely, Julie E., and Bradbury, Richard L., “An Evaluation of Heated Reclaimed Asphalt Pavement (RAP) Material and Wax Modified Asphalt for Use in Recycled Hot Mix Asphalt (HMA),” 86^{th} Annual Meeting of the Transportation Research Board (TRB), CD-ROM, January 2007.

There is a need for further apparatus and methods for testing asphalt mixes workability.

### SUMMARY OF THE INVENTION

In a first aspect, the present invention is directed to a method for testing the workability of asphalt mixtures. The method includes providing a first asphalt mixture at a first temperature in a container, rotating the container with the first asphalt mixture at a constant speed, providing a paddle having a vertical shaft, a plurality of laterally-extending elongated arms attached at first ends to the shaft and attached at second distal ends to a plurality of angled plates, a vertical dimension of the angled plates being greater than a vertical dimension of the arms, automatically measuring the torque applied to the paddle while the container with the first asphalt mixture is rotated at the constant speed, automatically measuring the temperature of the first asphalt mixture while the container with the first asphalt mixture is rotated at the constant speed, and stopping the rotation of the container with the first asphalt mixture once the first asphalt mixture cools to a second temperature different from the first temperature.

In a second aspect, the present invention is directed to a method for testing the workability of asphalt mixtures. The method includes providing a first asphalt mixture at a first temperature in a container, rotating the container with the first asphalt mixture at a constant speed, positioning a paddle in the first asphalt mixture in the container, automatically measuring the torque applied to the paddle and automatically measuring the temperature of the first asphalt mixture while rotating the container with the first asphalt mixture, automatically displaying on a display in real-time a graph of the torque verses time and in real-time a graph the temperature verses time for the measured torque and temperature while rotating the container with the first asphalt mixture, and stopping the rotation of the container once the first asphalt mixture cools to a second temperature different from the first temperature.

In a third aspect, the present invention is directed to an apparatus for testing the workability of asphalt mixtures. The apparatus includes a frame, a motor operably attached to the frame for rotating a turntable, a container releasably fixedly connectable to the turntable, and a paddle having a vertical shaft, a plurality of laterally-extending elongated arms attached at one end to the shaft and attached at a distal end to a plurality of angled plates, a vertical dimension of the angled plate being greater than a vertical dimension of the arm. A torque meter is operably attachable to the frame and to the paddle for measuring the torque applied to the paddle by the first asphalt mixture disposed in the rotating container and a temperature sensor is provided for measuring the temperature of the first asphalt mixture disposed in the rotating container.

In a fourth aspect, the present invention is directed to an apparatus for testing the workability of asphalt. The apparatus includes a frame, a motor operably attached to the frame for rotating a turntable, a container releasably fixedly connectable to the turntable, a paddle disposable in the container with a first asphalt mixture, a torque meter operably attachable to the frame and to the paddle for measuring the torque applied to the paddle by the first asphalt mixture disposed in the rotating container, a temperature sensor for measuring a temperature of the first asphalt mixture disposed in the rotating container, and means operable for automatically displaying on a display in real-time a graph of the torque verses time and in real-time a graph the temperature verses time for the measured torque and temperature while the first asphalt mixture is disposed in the rotating container.

In a fifth aspect, the present invention is directed at least one program storage device readable by a machine, tangibly embodying at least one program of instructions executable by the machine to perform the above-noted methods for testing the workability of asphalt mixtures.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and the accompanying drawings in which:

FIGS. 1-4 are perspective views of prior art asphalt workability testing devices;

FIG. 5 is a perspective view of one embodiment of an apparatus for testing hot asphalt workability in accordance with the present invention;

FIG. 6 is a front elevational view of a first embodiment of a paddle having angled paddles in accordance with the present invention;

FIG. 7 is a side elevational view of the paddle of FIG. 6;

FIG. 8 is a perspective view of a portion of the controller for controlling the speed of rotation of the container via the turntable in the apparatus of FIG. 5;

FIG. 9 is a view of a display screen generated by a data acquisition software program of the apparatus of FIG. 5;

FIGS. 10 and 11 are graphs generated in real-time of the raw measurements of torque verses temperature for testing asphalt mixtures using the apparatus of FIG. 5;

FIGS. 12 and 13 are graphs generated in real-time plots of torque measurements on one vertical axis and temperature measurements the other vertical axis verses time for testing an asphalt mixture using the apparatus of FIG. 5;

FIGS. 14 and 15 are graphs of torque verses temperature models derived from the raw measurements using the apparatus of FIG. 5, along with models for testing a control mixture and other mixtures having different additives for comparison;

FIGS. 16 and 17 are views of a second embodiment of a paddle for use in the apparatus of FIG. 5;

FIGS. 18-21 are views of two additional embodiments of paddle designs for use in the apparatus of FIG. 5; and

FIGS. 22 and 23 are flowcharts of methods for testing the workability of asphalt mixtures in accordance with the present invention.

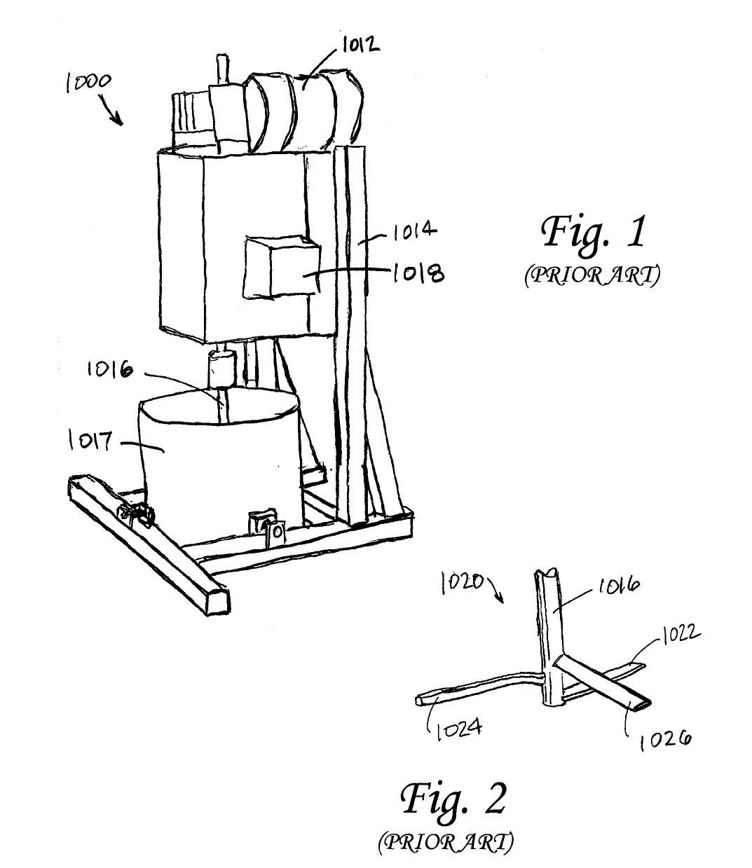

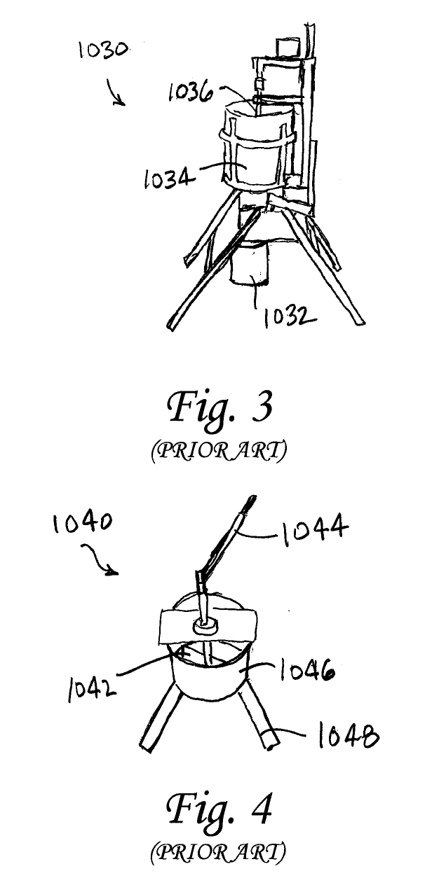

### DETAILED DESCRIPTION OF THE INVENTION

This present invention is directed in one aspect to an improved asphalt mix workability testing apparatus wherein a paddle is placed in a rotating container (at variable speeds) containing the asphalt mix. The resultant torque that the asphalt mix applies to the stationary paddle shaft is measured with a torque meter. Correspondingly, the temperature of the asphalt mix is also measured with a thermocouple in the shaft and/or an infrared thermocouple suspended above the asphalt mix container. As the asphalt mix cools, the resultant torque values that the asphalt mix imparts on the paddle shaft increase, thereby resulting in torque and temperature measurements that are utilized to develop torque verses temperatures curves and resultant models.

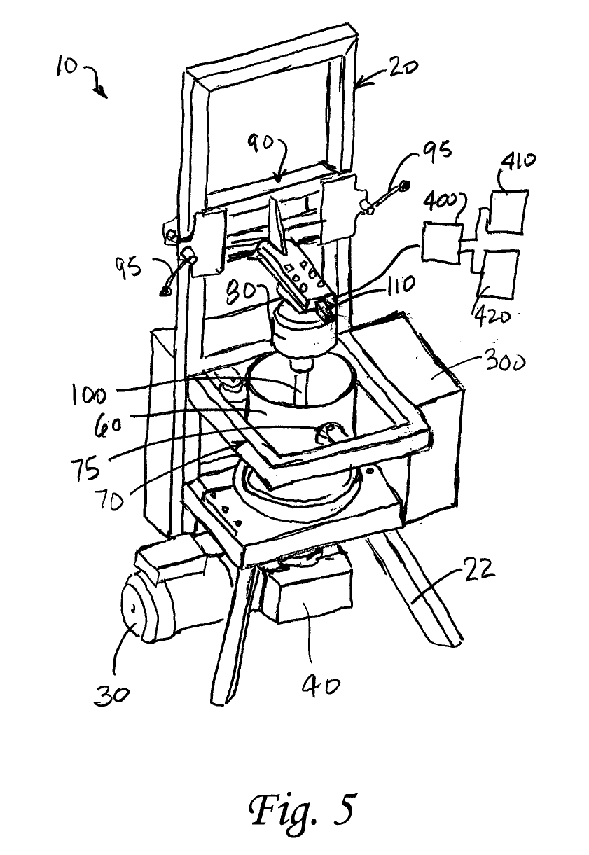

FIG. 5 illustrates one embodiment of an apparatus 10 in accordance with the present invention for testing asphalt mix workability. Exemplary apparatus 10 is configured as a floor standing version. For example, apparatus 10 may include a frame 20 which is supported on the ground by a plurality of legs 22, and a motor 30 operably connected to a gear box 40 for rotating a turntable 50. A container 60 having an open top, a closed bottom, and a sidewall is removably and releasably attachable to the turntable for containing an asphalt mix during testing. A guide 70 having a plurality of wheels 75 guides the rotating container. A torque meter 80 is operably attachable to the frame via an adjustable support 90 having a pair of adjustably and releasably attachable clamps 95. A paddle 100 is attachable to the torque meter and the adjustable support allows for lowering the paddle into and raising the paddle out of the container. The torque meter is operable for measuring the torque applied to the paddle due to the asphalt mix in the container as the container is rotated. A first temperature sensor 110 such as an infrared temperature sensor may be disposed above the container for measuring the surface temperature of the asphalt mixture in the container.

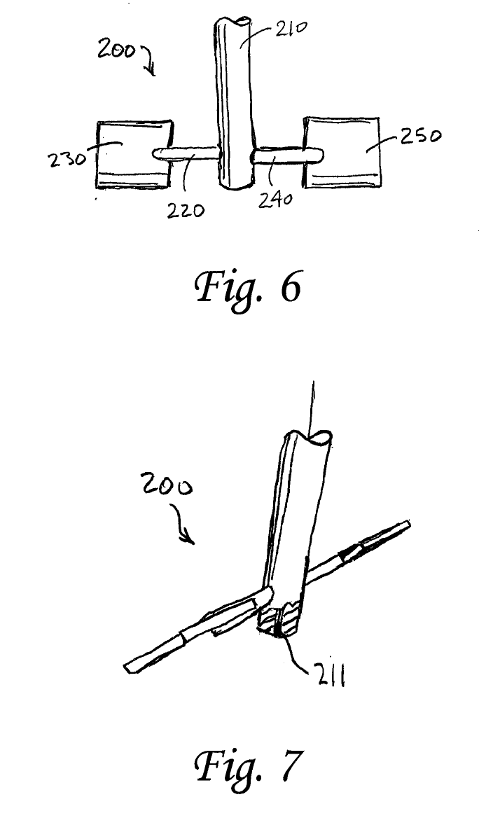

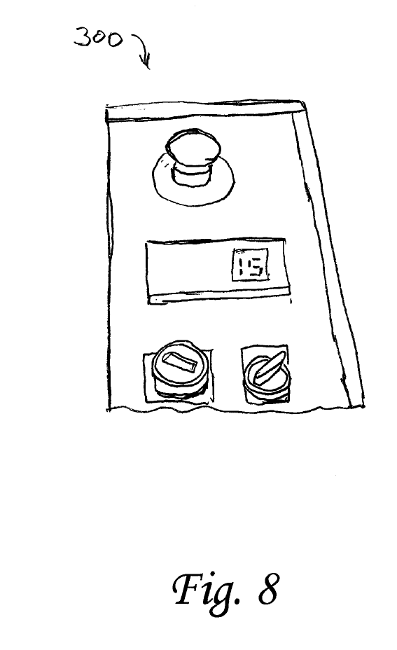

The present invention may employ paddles which may have different configurations for torque reaction measurement for use in the apparatus for testing the asphalt mix workability. For example, FIGS. 6 and 7 illustrate one embodiment of a paddle 200 in accordance with the present invention. Paddle 200 may include a vertically extending shaft 210, a first laterally-extending elongated arm 220 to which is attached a first plate 230, and a second a laterally-extending elongated arm 240 to which is attached a second plate 250. The plates are disposed at generally the same elevational height, angled at 45-degrees, and disposed 180-degrees from each other. The angled plates may be generally square, although other shapes may be suitably employed. The arm may have first vertical dimension and the angled plate may have a second vertical dimension greater than the first vertical dimension. For example, the second vertical dimension may be about 5 times the first vertical dimension. When the container is rotated, and thus the asphalt mix contained in the container is rotated, both plates push the asphalt mix down. In another embodiment of the paddle, the angled plates may be disposed at different angles. For example, one plate may be disposed so that when the container is rotated the asphalt is pushed upwardly and the other plate may be disposed so that when the container is rotated the other plate pushes the asphalt mix is pushed downwardly. In addition, a thermocouple temperature sensor 211 may be disposed inside the paddle shaft near the bottom of the paddle shaft for measuring the internal mix temperature of the asphalt mix.

The present invention may include an adjustable speed control 300, as shown in FIGS. 5 and 8, to allow an operator to adjustably vary the speed of the turntable, and thus, the container. For example, an operator may variably adjust the turntable rotation speed in increments of single rotations per minute (RPM) units from the range of 1 RPM to 50 RPM. The rotational speed may be measured by an optical tachometer (not shown) mounted below the turntable. The tachometer may be fixedly mounted on the frame. The tachometer may send out a beam which is reflected by a small reflector plate on the base which counts the revolutions. Internal on the tachometer may be a time measurement device that measures the time between counts. It will be appreciated that other means may be employed to measure the rotational speed.

In order to test both hot and cold asphalt mixes, the capacity and accuracy of the torque meter may allow measurement of up to 10,000 in/lbs. In addition, a smaller torque meter with a capacity of 1,000 in/lbs may be provided to more accurately obtain results for testing hot mixes. The torque meters may be interchangeable on apparatus 10.

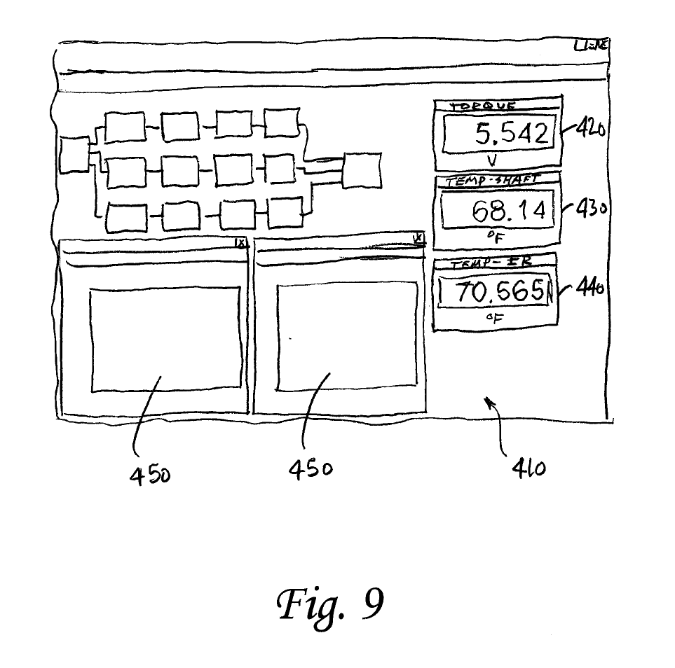

With reference again to FIG. 5, the present invention may further include a data acquisition unit 400, which may be operably connected to a monitor or display 410 and to an input device 420 such as a keyboard. In particular, the data acquisition unit may include a micro controller or processor operable to automatically collect, store, and record torque and temperature measurements in real-time which may be displayed on the display, as best shown in FIG. 9, as a torque measurement 420, a shaft temperature 430, and a surface temperature 440. The data may be analyzed by suitable programmed software and displayed on one or more displays 450. In another embodiment, the data acquisition unit may be operably connected to a computer such as a personal computer.

The infrared thermocouple may be directly connected to the data acquisition system. The infrared thermocouple provides an indication of the surface temperature of the asphalt mix. Additionally, the shaft of the paddle may be drilled out so that a thermocouple may be placed down the shaft to give an indication of the mix temperature below the surface. The data from both thermocouples may be incorporated into the data acquisition system to provide indications of both surface temperature and mix temperature. One of the other temperature measurements may be used or an average of the temperatures may be used. When the asphalt mixture loses temperature quickly, the use of a temperature sensor in the shaft may be preferred.

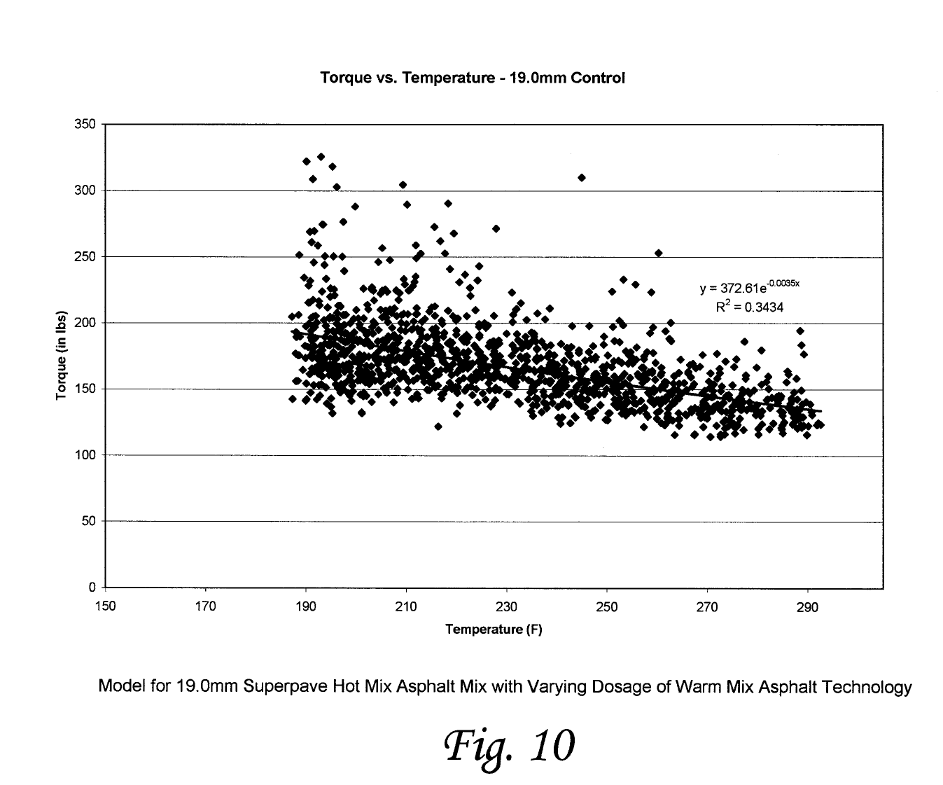

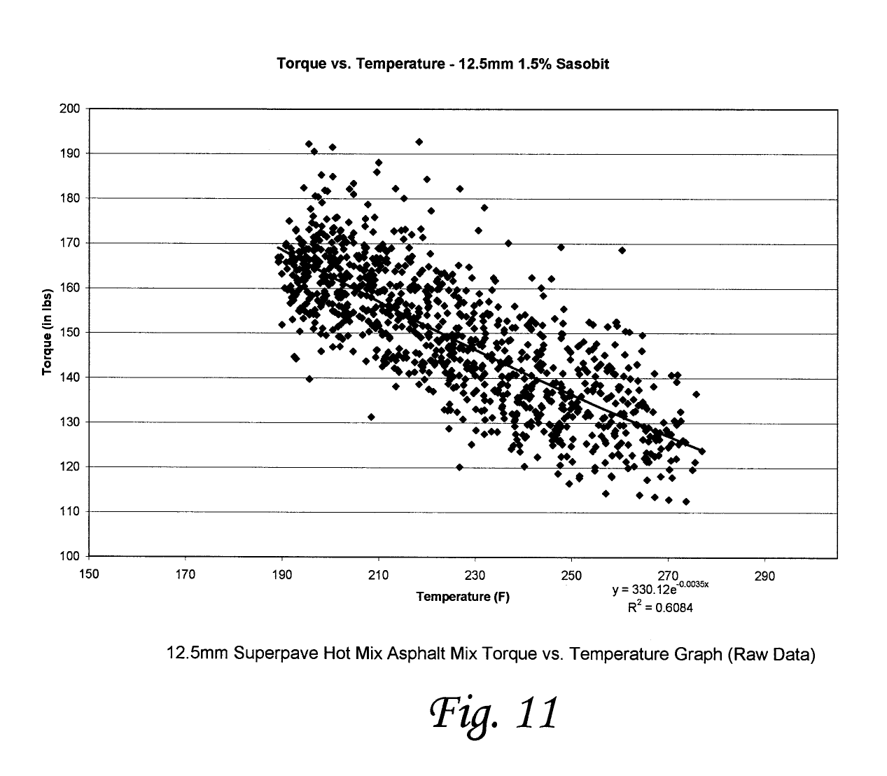

FIGS. 10 and 11 show graphs of raw data of the sampling of the torque measurement verses the temperature measurements for the hot asphalt mixes. For example, FIG. 10 illustrates the results for a control mixture, and FIG. 11 illustrates the results for a test mixture having, e.g., an additive utilized to improve the asphalt mixture workability known as a warm mix asphalt (WMA) additive.

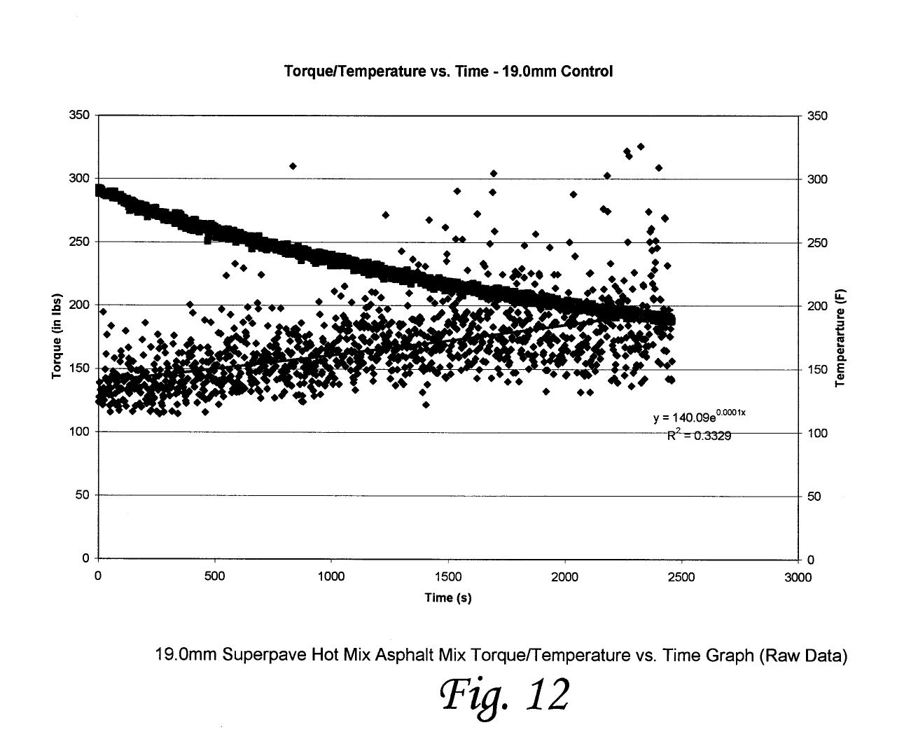

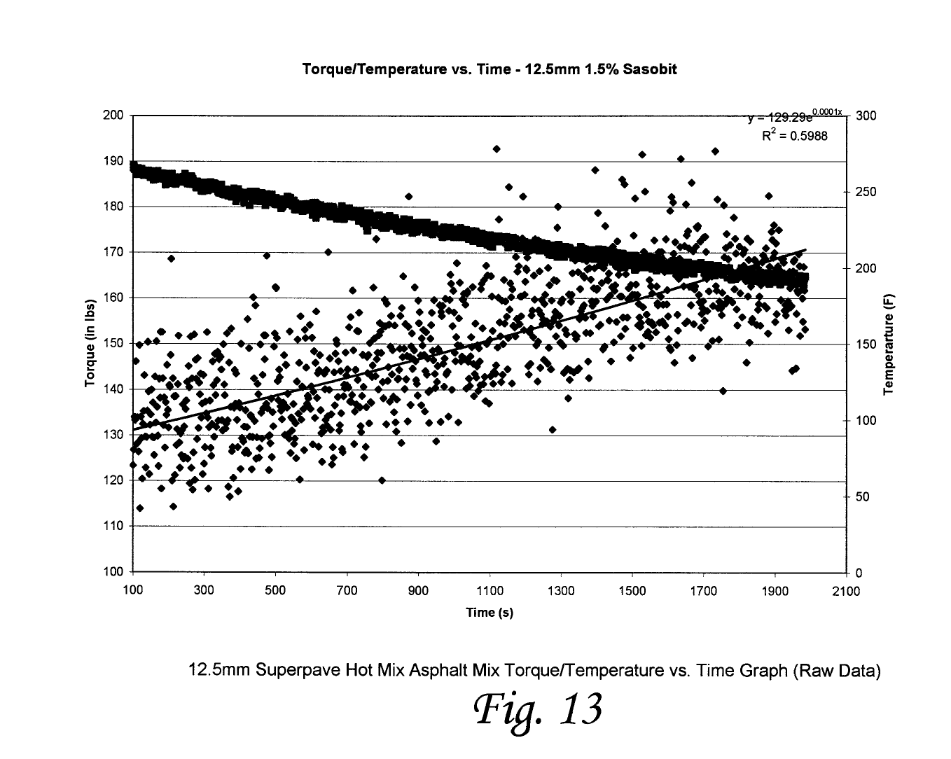

In addition, the processor, in accordance with the present invention, may automatically display a plot or graph 450 such as a display in real-time of the torque verses time and temperature versus time for the measured torque and temperature while testing the first asphalt mixture. For example, graphs shown in FIGS. 12 and 13 may be displayed on display 410.

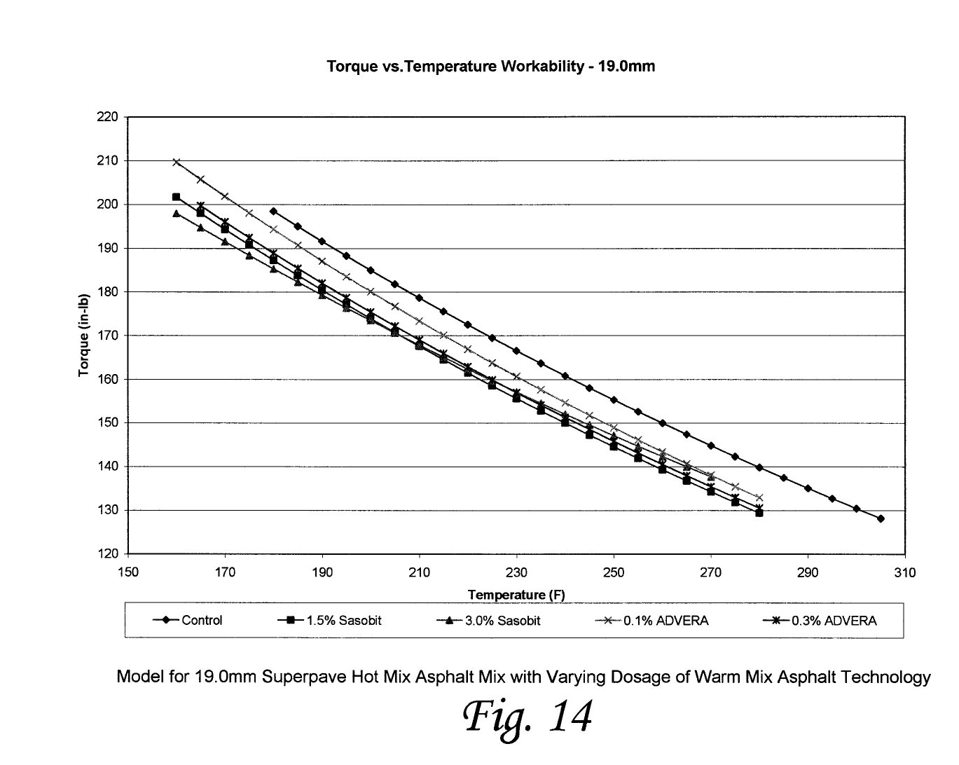

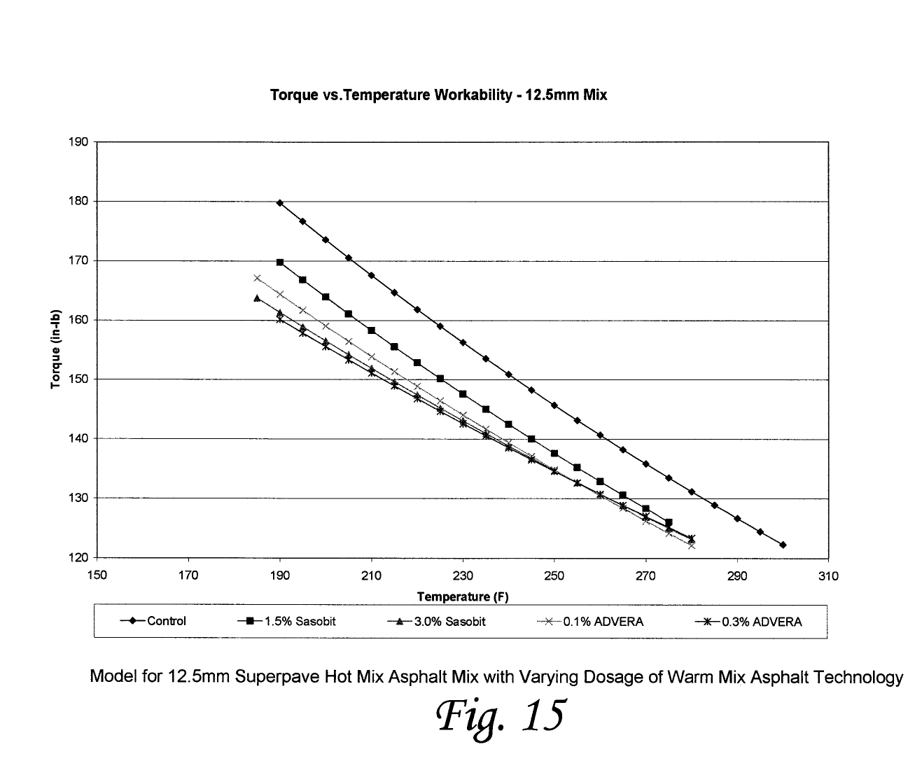

The processor may further process the data shown in FIGS. 10 and 11 and display a plot of the torque verses temperature for the measured torque and temperature. For example, FIGS. 14 and 15 each illustrate the plots of the results of the torque measurement verses the temperature measurements for a control hot mix asphalt, and in addition to the asphalt being tested, for example, four similar hot mix asphalts having the addition of additives. As observed, the different plots may be used for comparison to a control mixture (e.g., without an additive) to determine the effectiveness of the various additives. It will be appreciated by those skilled in the art that while the test asphalt is being tested, the various graph and plots may be generated and continually updated as the test progresses. With regards to the plots of torque versus temperature, alternatively the data may be transferred to a spreadsheet, program and the graph generated by the spreadsheet program.

With reference again to FIG. 5, apparatus 10 is capable of testing both types of mixtures both hot mix asphalt, cold asphalt mixes, or cold based mixes (emulsions). Cold mixtures have shown much higher torque values than hot mixes. To accommodate this, an increased torque meter size and corresponding upgrades to the rigidity of the frame structure may be employed.

The present invention may be utilized by hot mix asphalt paving contractors, state and federal agencies, academic research institutions, and private companies in order to evaluate the workability of the hot and cold asphalt mixtures.

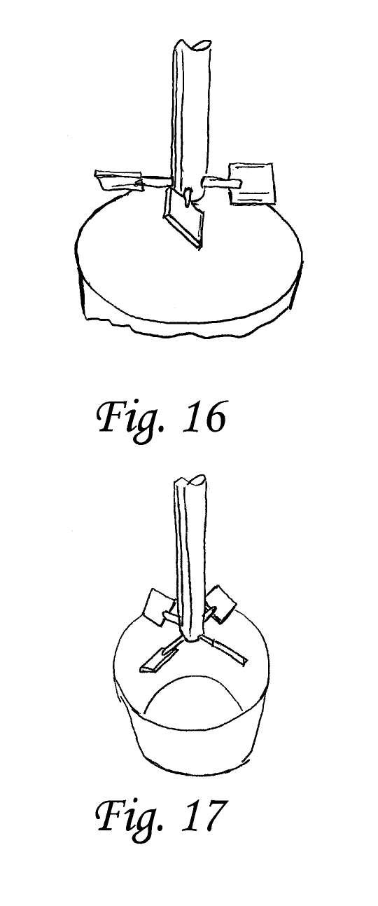

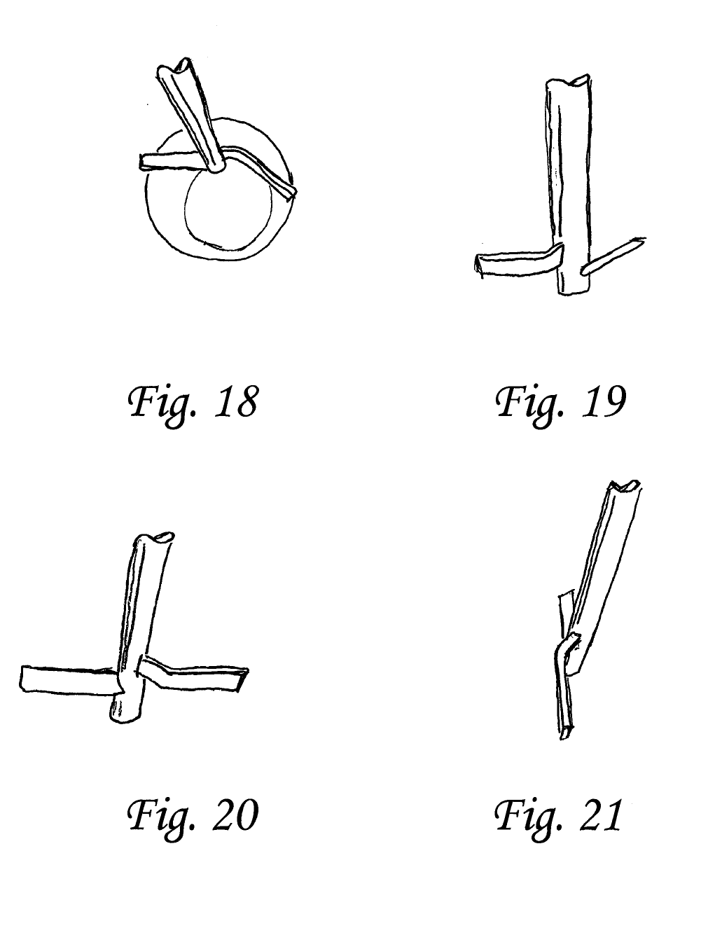

FIGS. 16-21 illustrate additional embodiments of a plurality of paddles for use in the apparatus in the accordance with the present invention. The shafts of the various disclosed paddles may be readily disconnected from the torque meter allowing quick change between the different paddles.

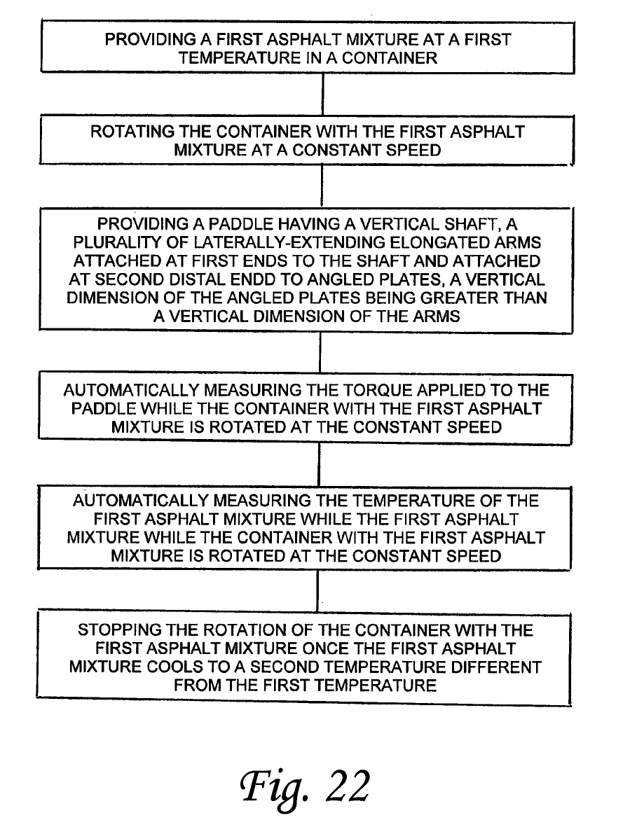

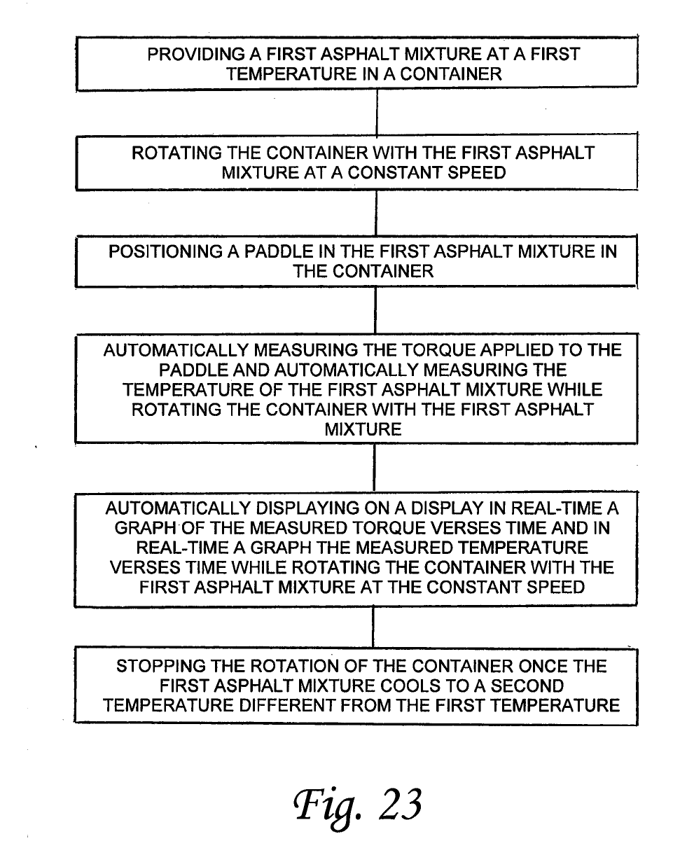

FIGS. 22 and 23 illustrate flowcharts of methods for testing the workability of asphalt mixtures in accordance with the present invention.

The apparatus of the present invention may allow testing of asphalt mixes that include, recycled asphalt shingles (RAS), reclaimed asphalt pavement (RAP), the addition of additives (e.g., warm mix asphalt technologies), and the use of different asphalt binders of varying grades and stiffnesses, aggregates of different types, and other components and new technologies used to form the asphalt mix.

Thus, while various embodiments of the present invention have been illustrated and described, it will be appreciated to those skilled in the art that many changes and modifications may be made thereunto without departing from the spirit and scope of the invention.

1. A method for testing the workability of asphalt mixtures, the method comprising:
providing a first asphalt mixture at a first temperature in a container;
rotating the container with the first asphalt mixture at a constant speed;
providing a paddle having a vertical shaft, a plurality of laterally-extending elongated arms attached at first ends to the shaft and attached at a distal second ends to angled plates, a vertical dimension of the angled plates being greater than a vertical dimension of the arms;
automatically measuring the torque applied to the paddle while the container with the first asphalt mixture is rotated at the constant speed;
automatically measuring the temperature of the first asphalt mixture while the first asphalt mixture while the container with the first asphalt mixture is rotated at the constant speed; and
stopping the rotation of the container with the first asphalt mixture once the first asphalt mixture cools to a second temperature different from the first temperature.

2. The method of claim 1 wherein the plurality of angled plates are disposed at about the same vertical elevation.

3. The method of claim 2 wherein the plurality of angled plates are generally square.

4. The method of claim 3 wherein the plurality of angled plates are disposed at about 45-degrees relative to the vertical shaft.

5. The method of claim 2 wherein the plurality of angled plates comprises a pair of laterally outwardly-extending angled plates.

6. The method of claim 1 wherein at least one plate of the paddle is operable to push at least a portion of the first asphalt mixture downwardly in the container and at least one plate of the paddle is operable to push at least a portion of the first asphalt mixture upwardly in the container.

7. The method of claim 1 wherein the rotating comprises rotating the container and the first asphalt mixture at a speed greater than 15 revolutions per minute.

8. The method of claim 1 further comprising automatically displaying on a display in real-time a graph of the torque verses time and the temperature verses time for the measured torque and temperature while testing the first asphalt mixture.

9. The method of claim 8 wherein the automatically displaying on the display in real-time the graph of the torque verses time and the temperature verses time comprises automatically displaying on the display in real-time torque along a first vertical axis, temperature along a second vertical axis, and time along a common horizontal axis.

10. The method of claim 8 wherein the automatically measuring the temperature comprises measuring a surface temperature of the first asphalt mixture using an infrared sensor and measuring an internal temperature of the first asphalt mixture using a thermocouple disposed in the paddle, and the automatically displaying on the display in real-time the graph of the torque verses time and the temperature verses time is based on temperature measurement readings from the first temperature sensor and the second temperature sensor.

11. The method of claim 1 further comprising displaying on a display a graph of the torque verses temperature for testing the first asphalt mixture, and at least one of a) measured torque and temperature for testing with the paddle a control asphalt mixture and b) measured torque and temperature for testing with the paddle a second asphalt mixture different from the first asphalt mixture.

12. The method of claim 11 wherein the measuring the temperature comprises measuring a surface temperature of the first asphalt mixture using an infrared sensor and measuring an internal temperature of the first asphalt mixture using a thermocouple disposed in the paddle, and the automatically displaying on the display the graph of the torque verses temperature for the measured torque and temperature for testing the first asphalt mixture is based on temperature measurement readings from said first temperature sensor and said second temperature sensor.

13. The method of claim 1 wherein the first asphalt mixture comprises aggregate, a binder, and a first additive, and further comprising automatically displaying on a display in real-time a graph of the torque verses time and the temperature verses time for the measured torque and temperature while testing the first asphalt mixture comprising the aggregate, the binder, and the first additive.

14. The method of claim 13 further comprising displaying on a display a graph of the torque verses temperature for the measured torque and temperature while mixing the first asphalt mixture comprising aggregate, the binder, and the first additive, and at least one of a) measured torque and temperature for testing with the paddle a control asphalt mixture comprising the aggregate and the binder without the first additive, and b) measured torque and temperature for testing with the paddle a second asphalt mixture of the aggregate, the binder, and a second additive different from the first additive.

15. The method of claim 1 wherein the automatically measuring the temperature comprises automatically measuring the temperature of the first asphalt mixture with a temperature sensor disposed in the paddle.

16. The method of claim 1 wherein the automatically measuring the temperature comprises automatically measuring the surface temperature of the first asphalt mixture using an infrared sensor and measuring an internal temperature of the first asphalt mixture using a thermocouple disposed in the paddle.

17. The method of claim 1 wherein the providing the first asphalt mixture comprises providing a hot asphalt mixture.

18. The method of claim 1 wherein the providing the first asphalt mixture comprises providing a cold asphalt mixture.

19. A method for testing the workability of asphalt mixtures, the method comprising:
providing a first asphalt mixture at a first temperature in a container;
rotating the container with the first asphalt mixture at a constant speed;
positioning a paddle in the first asphalt mixture in the container;
automatically measuring the torque applied to the paddle and automatically measuring the temperature of the first asphalt mixture while rotating the container with the first asphalt mixture;
automatically displaying on a display in real-time a graph of the measured torque verses time and in real-time a graph the measured temperature verses time while rotating the container with the first asphalt mixture at the constant speed; and
stopping the rotation of the container once the first asphalt mixture cools to a second temperature different from the first temperature.

20. The method of claim 19 wherein the automatically displaying on the display in real-time the graph of torque verses time and the graph of temperature verses time comprises automatically displaying torque along a first vertical axis, temperature along a second vertical axis, and time along a common horizontal axis.

21. The method of claim 19 wherein the automatically measuring the temperature comprises automatically measuring the temperature of the first asphalt mixture with a temperature sensor disposed in the paddle.

22. The method of claim 19 wherein the automatically measuring the temperature comprises automatically measuring the surface temperature of the first asphalt mixture using an infrared sensor and automatically measuring an internal temperature of the first asphalt mixture using a thermocouple disposed in the paddle.

23. The method of claim 22 wherein the automatically displaying on the display in real-time the graph of the torque verses time and in real-time the graph the temperature verses time is based the first temperature measurements and the second temperature measurements.

24. The method of claim 19 further comprising displaying on the display a graph of the torque verses temperature for testing the first asphalt mixture, and at least one of a) measured torque and temperature for testing with the paddle a control asphalt mixture and b) measured torque and temperature for testing with the paddle a second asphalt mixture different from the first asphalt mixture.

25. The method of claim 24 wherein the automatically measuring the temperature of the first asphalt mixture comprises automatically measuring a first temperature of the shaft of the paddle disposed in the first asphalt mixture, and automatically measuring a second temperature of the surface of the first asphalt mixture, and wherein the displaying on the display the graph of the torque verses temperature for the measured torque and temperature for testing the first asphalt mixture is based the first temperature measurements and the second temperature measurements.

26. The method of claim 19 wherein the rotating comprises rotating the container at a speed greater than 15 revolutions per minute.

27. The method of claim 19 wherein the first asphalt mixture comprises aggregate, a binder, and a first additive, and further comprising automatically displaying on a display in real-time a graph of the torque verses time and the temperature verses time for the measured torque and temperature while testing the first asphalt mixture comprising the aggregate, the binder, and the first additive.

28. The method of claim 19 further comprising displaying on a display in real-time a graph of the torque verses temperature for the measured torque and temperature while mixing the first asphalt mixture comprising aggregate, the binder, and the first additive, and at least one of a) measured torque and temperature for testing with the paddle a control asphalt mixture comprising the aggregate and the binder without the first additive, and b) measured torque and temperature for testing with the paddle a second asphalt mixture of the aggregate, the binder, and a second additive different from the first additive, for comparison.

29. The method of claim 19 wherein the providing the first asphalt mixture comprise providing a hot asphalt mixture.

30. The method of claim 19 wherein the providing the first asphalt mixture comprises providing a cold asphalt mixture.

31. An apparatus for testing the workability of asphalt mixtures, said apparatus comprising:
a frame;
a motor operably attached to said frame for rotating a turntable;
a container releasably fixedly connectable to said turntable;
a paddle having a vertical shaft, a plurality of laterally-extending elongated arms attached at first ends to said shaft and attached at distal second ends to angled plates, a vertical dimension of said angled plates being greater than a vertical dimension of said arms;
a torque meter operably attachable to said frame and to said paddle for measuring the torque applied to said paddle by the first asphalt mixture disposed in said rotating container; and
a temperature sensor for measuring the temperature of the first asphalt mixture disposed in said rotating container.

32. The apparatus of claim 31 wherein said plurality of angled plates are disposed at about the same vertical elevation.

33. The apparatus of claim 32 wherein said plurality of angled plates are generally square.

34. The apparatus of claim 33 wherein said plurality of angled plates are disposed at about 45-degrees relative to said vertical shaft.

35. The apparatus of claim 31 wherein said plurality of angled plates comprises a pair of angled plates.

36. The apparatus of claim 31 wherein at least one plate of the paddle is operable to push at least a portion of the first asphalt mixture downwardly in the container, and at least one plate of the paddle is operable to push at least a portion of the first asphalt mixture upwardly in the container.

37. The apparatus of claim 31 wherein the temperature sensor is disposed in said shaft of said paddle.

38. The apparatus of claim 31 wherein the temperature sensor comprises an infrared sensor.

39. The apparatus of claim 31 wherein the temperature sensor comprises a first temperature sensor disposed in said shaft of said paddle, and a second temperature sensor comprising an infrared sensor disposed about the container.

40. An apparatus for testing the workability of asphalt, the apparatus comprising:
a frame;
a motor operably attached to said frame for rotating a turntable;
a container releasably fixedly connectable to said turntable;
a paddle disposable in said container with a first asphalt mixture;
a torque meter operably attachable to said frame and to said paddle for measuring the torque applied to said paddle by the first asphalt mixture disposed in said rotating container;
a temperature sensor for measuring a temperature of the first asphalt mixture disposed in said rotating container;
means operable for automatically displaying on a display in real-time a graph of the torque verses time and in real-time a graph the temperature verses time for the measured torque and temperature while the first asphalt mixture is disposed in said rotating container.

41. The apparatus of claim 40 further comprising means operable for displaying on the display a graph of the torque verses temperature for the measured torque and temperature for testing the first asphalt mixture, and at least one of a) measured torque and temperature for testing with the paddle a control asphalt mixture and b) measured torque and temperature for testing with the paddle a second asphalt mixture different from the first asphalt mixture, for comparison.

42. The apparatus of claim 40 wherein the temperature sensor comprises a first temperature sensor disposed in said shaft of said paddle, and a second temperature sensor comprising an infrared sensor disposed above the container, and said graph of the torque verses temperature is based on temperature measurement readings from said first temperature sensor and said second temperature sensor.

43. The apparatus of claim 40 wherein said means operable for automatically displaying on the display in real-time the graph of torque verses time and the graph of temperature verses time comprises means for displaying torque along a first vertical axis, temperature along a second vertical axis, and time along a common horizontal axis.

44. The apparatus of claim 40 wherein said temperature sensor is disposed in said paddle.

45. The apparatus of claim 40 wherein said temperature sensor comprises an infrared sensor for measuring an exterior surface temperature of the mixture.

46. The apparatus of claim 40 wherein the temperature sensor comprises a first temperature sensor disposed in said shaft of said paddle, and a second temperature sensor comprising an infrared sensor disposed about the container, and said measured temperature verses time is based on temperature measurement readings from said first temperature sensor and said second temperature sensor.

47. The apparatus of claim 40 wherein said motor is operable to rotate said container at a speed greater than 15 revolutions per minute.

48. At least one program storage device readable by a machine, tangibly embodying at least one program of instructions executable by the machine to perform a method for testing the workability of asphalt mixtures, said method comprising:
providing a first asphalt mixture at a first temperature in a container;
rotating the container with the first asphalt mixture at a constant speed;
providing a paddle having a vertical shaft, a plurality of laterally-extending elongated arms attached at first ends to the shaft and attached at a distal second ends to angled plates, a vertical dimension of the angled plates being greater than a vertical dimension of the arms;
automatically measuring the torque applied to the paddle while the container with the first asphalt mixture is rotated at the constant speed;
automatically measuring the temperature of the first asphalt mixture while the first asphalt mixture while the container with the first asphalt mixture is rotated at the constant speed; and
stopping the rotation of the container with the first asphalt mixture once the first asphalt mixture cools to a second temperature different from the first temperature.

49. At least one program storage device readable by a machine, tangibly embodying at least one program of instructions executable by the machine to perform a method for testing the workability of asphalt mixtures, said method comprising:
providing a first asphalt mixture at a first temperature in a container;
rotating the container with the first asphalt mixture at a constant speed;
positioning a paddle in the first asphalt mixture in the container;
automatically measuring the torque applied to the paddle and automatically measuring the temperature of the first asphalt mixture while rotating the container with the first asphalt mixture;
automatically displaying on a display in real-time a graph of the measured torque verses time and in real-time a graph the measured temperature verses time while rotating the container with the first asphalt mixture at the constant speed; and
stopping the rotation of the container once the first asphalt mixture cools to a second temperature different from the first temperature.
